(19) United States
(12) Patent Application Publication
(10) Pub. No.: US 2025/0196973 A1
(43) Pub. Date: Jun. 19, 2025

(54) Turbine Platform Current Energy Conversion System With Debris Protection

(71) Applicant: LITTORAL POWER SYSTEMS, INC., New Bedford, MA (US)

(72) Inventors: David Duquette, Fairhaven, MA (US); Katherine Leighton, Media, PA (US); Ryan Cook, Pickerington, OH (US); Sylas Horowitz, Cambridge, MA (US); C. Eben Franks, Bourne, MA (US); Ravi Challa, South Dartmouth, MA (US); Doug Slocum, Cumberland, ME (US); Jean-Marc Guindon, Herring Cove (CA); Louis Manuge, Hammonds Plains (CA)

(73) Assignee: LITTORAL POWER SYSTEMS, INC., New Bedford, MA (US)

(21) Appl. No.: 18/618,980

(22) Filed: Mar. 27, 2024

Related U.S. Application Data
(60) Provisional application No. 63/611,667, filed on Dec. 18, 2023.

(51) Int. Cl. B63B 35/44; F03B 3/04; F03B 11/08

(52) U.S. Cl. CPC B63B 35/44; F03B 3/04; F03B 11/08; B63B 2035/4466

(57) ABSTRACT

A turbine platform includes an above water surface portion of catamaran-based design, the above water surface portion supporting a rotating turntable, which in turn supports one or more hydro-turbines, one or more generators, and one or more transmission systems, and a below water surface portion, the below water surface portion including two or more retractable hydro-turbines linked to a generator in the above water surface portion.

### CROSS-REFERENCE TO RELATED APPLICATION(S)

The present application claims priority benefit of U.S. Provisional Application No. 63/611,667, filed Dec. 18, 2023, which is herein incorporated by reference in its entirety.

### STATEMENT OF RIGHTS TO INVENTIONS MADE UNDER FEDERALLY SPONSORED RESEARCH AND DEVELOPMENT

This invention was made with government support under DE-AR0001447 awarded by the Department of Energy. The government has certain rights in the invention.

### BACKGROUND OF THE INVENTION

The present invention relates to energy production, and more particularly to a turbine platform current energy conversion system with debris protection.

Much attention is directed at the present time to the generation of electricity from renewable sources. Windmills are widely employed in many parts of the world. Much interest has been shown in generating electricity from wave power and from the kinetic energy in moving water in rivers and passing through tidal inlets. In some parts of the world, fast-running tides can provide a source of energy that can be harnessed by placing turbines in the path of bi-directional tidal flows (“tidal streams”), related to the rise and fall of tidal waters coursing through narrow channels near-shore. The tidal turbines convert kinetic energy of flowing water into electricity, which is then fed directly into nearby loads or into the electrical grid to power homes, businesses, and industrial installations. There is wide and growing interest in harnessing kinetic energy from currents in rivers as well.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a turbine platform including an above water surface portion of catamaran-based design, the above water surface portion supporting a rotating turntable, which in turn supports one or more hydro-turbines, one or more generators, and one or more transmission systems, and a below water surface portion, the below water surface portion including two or more retractable hydro-turbines linked to a generator in the above water surface portion.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

These and other features, aspects, and advantages of the present invention will become better understood with reference to the following description, appended claims, and accompanying drawings where:

FIG. 1 illustrates an exemplary turbine platform.

FIG. 2 illustrates an exemplary outboard view of a moored turbine platform.

FIG. 3 illustrates an underwater view of a moored turbine platform.

FIG. 4 illustrate transmission mountings.

FIG. 5 illustrates the structure immediately beneath the transmission mounts.

FIG. 6 illustrates design drivers.

FIG. 7 illustrates a cross-section of an exemplary retractable turbine structure.

FIG. 8 illustrates a nacelle.

FIG. 8A illustrates an alternate embodiment.

FIG. 8B illustrates a table.

FIG. 8C illustrates a table.

FIG. 9 illustrates an exemplary debris management system.

FIG. 10 illustrates an exemplary floating boom system.

FIG. 10A illustrates an exemplary sonar image.

FIG. 10B illustrates kelp ready for deployment in the laboratory tow tank.

FIG. 10C illustrates an exemplary sonar image.

FIG. 11 illustrates exemplary sizing parameters.

FIG. 12 illustrates exemplary transmission components.

FIG. 13 illustrates an exemplary nacelle.

FIGS. 14, 15 and 16 illustrate an exemplary platform design.

FIG. 17 illustrates an exemplary lightweight superstructure.

FIG. 18A illustrates an exemplary transmission system.

FIG. 18B illustrates sample parameters.

FIG. 19 illustrates an exemplary transmission module.

FIG. 21 illustrates an exemplary debris strike mitigation subsystem.

FIG. 22 illustrates an exemplary damper-impact fuse.

FIG. 23 illustrates an exemplary 4-bar linkage retraction system.

Like reference symbols in the various drawings indicate like elements.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

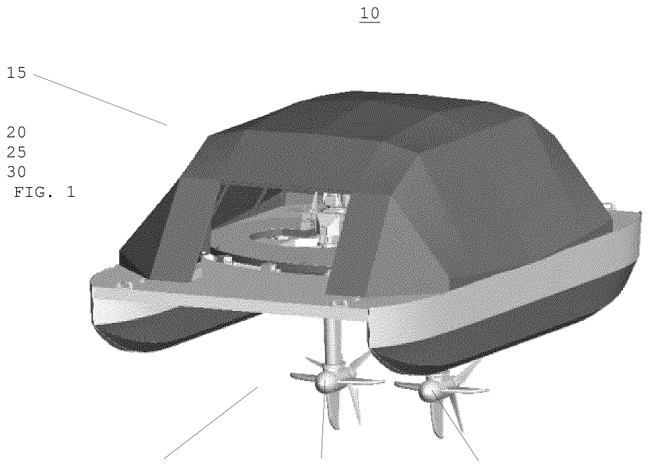

In FIG. 1, an embodiment of an exemplary a turbine platform 10 is illustrated. The turbine platform 10 generally includes an above water surface portion 15 and a below water surface portion 20. More specifically, as is described fully below, a catamaran-based design of the above water surface portion 15 supports a rotating turntable, which in turn supports one or more hydro-turbines, one or more generators, and one or more transmission systems. The below water surface portion 20 includes two or more retractable hydro-turbines 25, 30 linked to a generator in the above water surface portion 15. The two or more retractable turbines 25, 30 are located downstream of a transmission arm, and are raked back to deflect debris. Therefore, this design does not rely on the smart debris deflector. Moreover, the design illustrates a mixed approach, i.e., retractable submersible turbines linked to a generator in the dryness of the above water surface portion 15.

The turbine platform 10 enables bringing turbines 25, 30 above water for maintenance with a remote control, which in turn minimizes a need for divers, and enables inspection from the shore with drones. Having a generator above water in the above water surface portion 15 extends its life cycle, reliability and uptime. Having a generator above water in the above water surface portion 15 also enables easy replacement if a need should arise.

Also as fully described below, the turbine platform 10 incorporates smart debris deflector. This smart debris deflector replaces a dedicated debris deflection structure with smart network controls that signals the turbines 25, 30 to be rotated out of the way upon debris encounters.

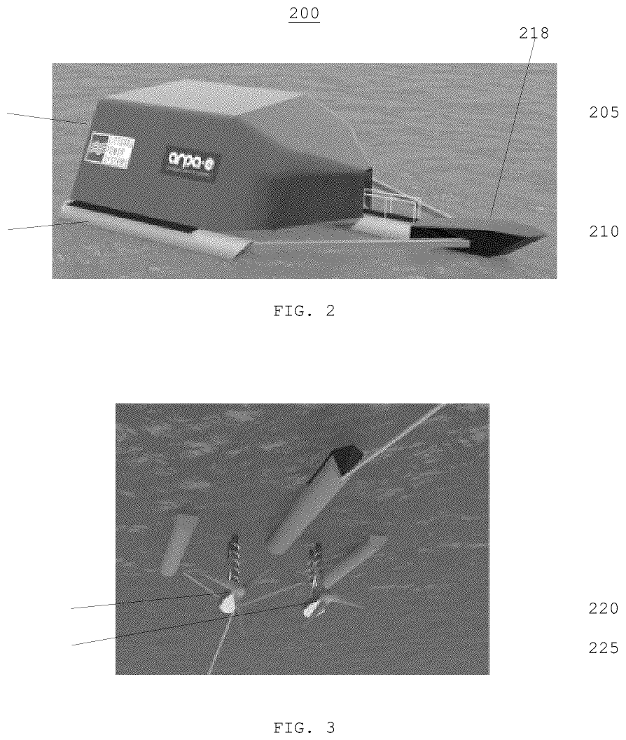

In FIG. 2, an exemplary outboard view of a moored turbine platform 200 includes an above water surface portion 205 supported on the water by two pontoons 210, 215 and a forward bow structure 218, while FIG. 3 illustrates an underwater view of the moored turbine platform 200 having two turbines 220, 225. Also illustrated are mooring line 230 affixed to the forward bow structure 218 and mooring line 235 affixed to the two pontoons 210, 215. The forward bow structure 218 adds extra buoyancy during high current (and drag) situations, and in waves and other vessel wakes.

The views shown in FIG. 2 and FIG. 3 illustrate a floating, skeletal multi-hull platform 200 that enables two axial turbines 210, 215 to be deployed in a non-reversing current, such as rivers or ocean current, and retracted for maintenance onboard without diver support.

In should be noted that in one embodiment, the moored turbine platform 200 is modified to be used in reversing current locations by including a turret post internal to the platform and mooring the turret post, and then the platform rotates around it.

In one embodiment, the turbine platform 200 includes an aft anchor and mooring bridle, which ensure the turbine platform 200 does not sway or yaw excessively into shipping channel, and provides a pathway for shore power cabling.

The turbine platform described above is designed with an emphasis on low structure weight to lower manufacturing costs. For example, the pontoon hulls are spiral-welded steel pipe, while the above water surface portion is a lightweight fabric superstructure that provides covering for weather protection.

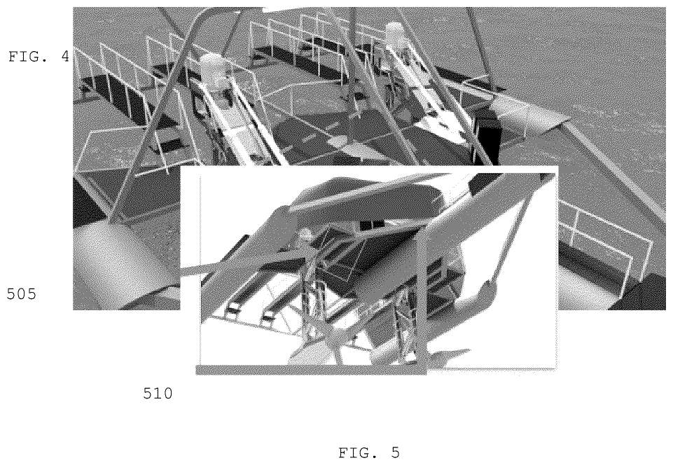

As shown in FIG. 4, within the above water surface portion turbine, transmissions are mounted to a cross-structure spanning between hulls. Here, a majority of pitching moment and drag loads are transferred into the center hull, while the side hulls provide transverse stability and truss support. Power generators 405, 410 are positioned on top of transmission structures where components internal to the structures transfer power from turbine to generator.

FIG. 5 illustrates the structure immediately beneath the transmission mounts 505 and the primary structural tie-in to hull 510.

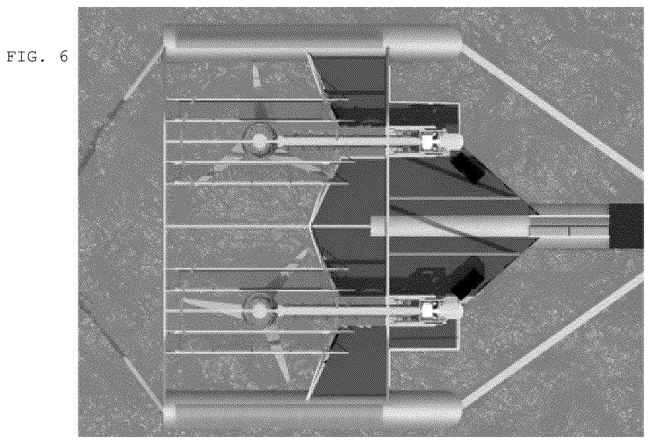

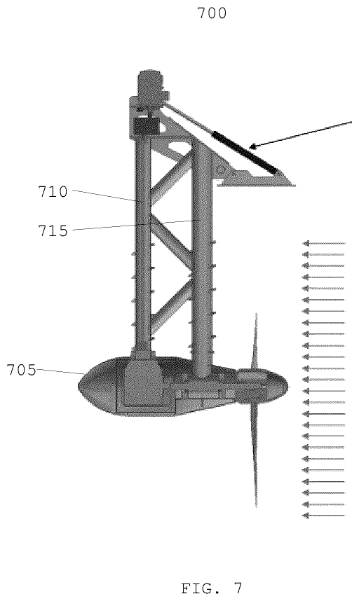

FIG. 6 illustrates design drivers 600 for one specific implementation of a turbine platform, i.e., a 263 KW version. The geometry of positioning two 06.2 m diameter rotors suspended on a transmission system structure is fashioned to enable them to be removed from the water drives the vessel beam. More specifically, in this one example, the geometry includes 0.5 m clearance between rotor tips and 0.1 m clearance between rotor tip and hull when being raised. A depth of the rotors and their drag generates a large trimming moment at high current speeds while a pitch range has minimal impact on turbine performance.

As shown in FIG. 7, a cross-section of an exemplary retractable turbine structure 700 is illustrated. A turbine 705 is linked to components within an above water surface portion (not shown) by dual hydraulic cylinders 710, 715. The dual hydraulic cylinders 710, 715 enable turbine deployment and recovery. In addition, the dual hydraulic cylinders 710, 715 provide ease of maintenance because rotors and nacelle components can be positioned out of the water; there is no need for divers. This design also enables retraction by remote control, which translates to lower cost inspections, and an ability of using drones operated from shore rather than vessel transported humans. Turbines can be raised above water for easier access to turbine and drive components.

In one embodiment, retraction of the turbine 705 can be triggered by a smart debris deflector, thus moving the rotor blades of the turbine out of the way of large debris.

This design also enables an option for emergency removal of turbine and transmission from water.

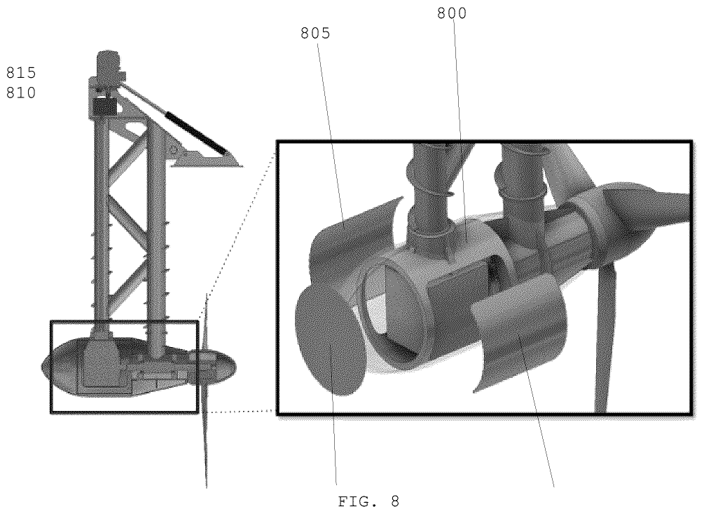

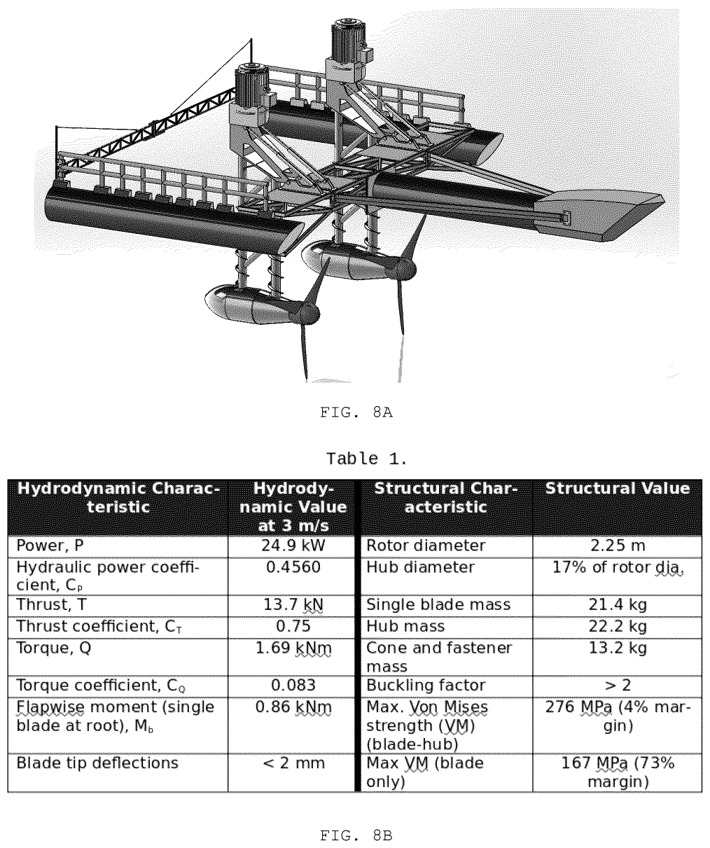

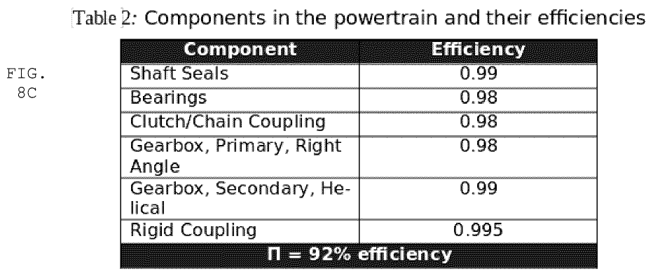

As shown in FIG. 8, a nacelle 800 includes multiple removable access panels 805, 810, 815 to reduce service and inspection time for turbine bearings, drive shaft and gearbox. In one embodiment, the removable access panels 805, 810, 815 are at a working height to avoid need for staging.

In alternate embodiments of the turbine platform lift points are integrated into the vessel superstructure, such as fixed pad eyes, or an I-beam trolley with chain fall.

Ample lighting may be provided throughout covered region of the above water surface portion for visibility.

Deck cleats and ladders may be added on side pontoons for maintenance vessel approach and docking to turbine platform.

In one embodiment, a catwalk is eliminated and the structure relies on a tender vessel to come along side and integrate for human required maintenance activities. This approach is lower cost for a farm of devices.

The embodiment shown in FIG. 8A consists of counter-rotating axial flow turbines mounted with a transmission system that adjusts from the low-speed rotor to a moderate-speed generator. The primary innovation is a retractable turbine with a generator and electrical system placed out of the water. The turbine is rotated out of and above the water to make it easy to access items and perform maintenance without the need for divers. This feature also makes the system survivable in extreme conditions and allows the rotors to be moved out of the way of marine species as needed, ensuring that environmental impact is minimized. The turbine is retracted by a hydraulic cylinder actuated by a solenoid connected to a control box that can be programmed for timed actuation or can be triggered by a radio signal, e.g., from a remote control similar to the mechanism in a garage door opener. The generators and all electrical components are above the water for easy access and to avoid damage from seal failure, since water ingress is such a prevalent failure mode in marine energy devices. The highest maintenance items, i.e., gearboxes, are designed to be held in cassettes, which are carrying frames that ensure it is held in place and meet critical tolerances making it easy to align and connect during installation and repair. The cassettes are located in the lower nacelle in an area where they are easy to access and replace when the turbines are rotated up out of the water. The turbine rotor blades are durable stainless steel and the connections at the hub are designed so that individual blades can be disconnected and replaced when the arms are rotated up.

A gate provides connection and stability across the aft pontoons through a truss arm and tension member. It is designed to open up and allow access to a maintenance tender. A support rail on each of the aft pontoons increases pontoon strength and stability while providing points for rigging and additional tender berths. Using a maintenance tender spreads the cost of maintenance equipment, e.g., a crane, over an array of devices rather than burdening every platform with that cost.

Specific design strategies for survival include:
Turbines are mounted on retractable arms that automatically lift them out of the water at excessive current speed.
Actuation of the retractable arm is designed to be triggered by a Smart Boom, which detects upstream debris and decides if it is damaging to the system.
The hydraulic mechanism for retraction includes a mechanical damper and fuse to attenuate loads.
The multi-hull design is inherently stable against cross-beam wind and the upstream pontoon cross-section is optimized for seakeeping.
Compliance is built into mechanical linkages and connections for energy absorption.
Flexibility is built into the mooring system to passively shed load.
The platform can be disconnected from mooring lines and towed to shore if needed.

In parallel with this focus on reliability and maintainability, the design has been through multiple iterations to optimize it for low cost through an emphasis on low structure weight, as well as the use of standard structural members and commercial off-the-shelf (COTS) components. Mass was reduced by approximately 30% during an optimization effort. The use of standard structural shapes lowers the manufacturing cost per unit mass vs. custom machined parts because these standard shapes are already produced at a massive scale.

The Hydrodynamic performance and structural characteristics of a 2.25 m diameter rotor for one embodiment of the subject invention is shown in FIG. 8B as Table 1.

In one embodiment, the system is designed to start producing power in currents of 0.7 m/s and to continue to produce power in currents up to 3.4 m/s. For this embodiment, higher currents than this are considered extreme conditions and the turbines are automatically rotated up out of the water to reduce the loads on the system. The expected power production is a product of one-half the density of the water, the area the turbine presents to the oncoming current, the cube of the current speed, and the efficiency of the device. The device efficiency is the product of the efficiencies of each component: rotor, drive train, generator and power electronics. The efficiency of the rotor is 0.456, as shown in Table 1. The estimated mechanical efficiency of the components in the powertrain is presented in FIG. 8C as Table 2. The components transmitting torque or causing friction in the system, from the turbine hub to the generator, are included. The electrical efficiency of the generator is >80% per the manufacturer. The power conversion system is assumed to be 98% efficient. The total efficiency of the system is the product of these four values, i.e., 0.329. With this total efficiency and two rotors at 3 m diameter in 3 m/s current the system will produce 58.8 KW of power.

The energy produced over a year's time depends on the frequency distribution of the current speed over that year and how the efficiency of the turbines and generators vary with this speed. For a candidate frequency distribution consider the Kootznahoo Inlet, where on Jun. 11, 2021, Littoral Power Systems (LPS), Inc. was granted a Preliminary Permit (P-15110) from the Federal Energy Regulatory Commission (FERC) to investigate the feasibility of a tidal energy project. It is near Angoon AK, which is located on Admiralty Island in Southeast AK about 56 miles south of Juneau. Angoon is an isolated community of about 420 residents, most of whom are Tlingit Alaskan Native Indigenous Peoples. It is only accessible by plane or ship. LPS senior scientists processed the data and developed 1D DYNLET and 2D versions of Delft3D circulation models. The highest current speed observed during the 3-day survey was 2.3 m/s. The 1D DYNLET model, however, simulated flow over a year at various points along the measured velocity transects and indicated higher velocities—the modeled current speed frequency distribution at this location is shown in FIG. 8B.

The resulting estimated energy produced at each increment of speed assuming a cut-in of 0.7 m/s and cut out of 3.4 m/s, and taking into account the fact that the efficiency of the rotors and generators drop off with speed, is shown in the right-hand image in FIG. 8B. Summing up these values yields an estimated annual energy generation of 65,376 kWh, which is enough to attract and support new business to Angoon, for example a cannery that could produce about 2,700 tons of canned fish or seafood a year.

As shown in FIG. 9, the full system 900 includes a includes deployment of multiple turbine platforms 905, 910 and a separately moored, floating debris detection, tracking and characterization boom system 915 positioned upstream of the multiple platforms 905, 910.

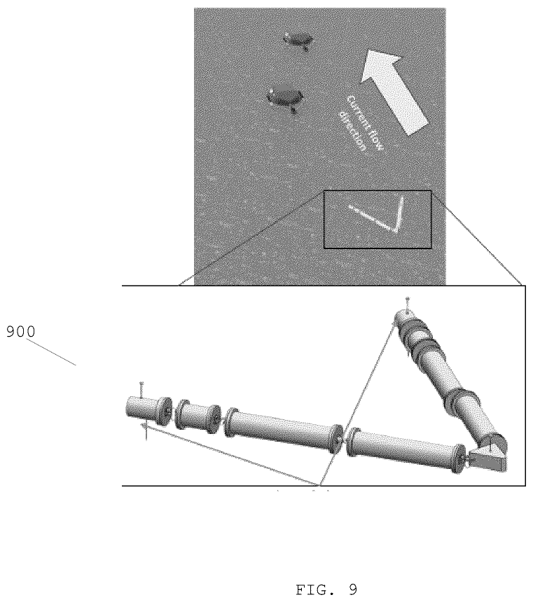

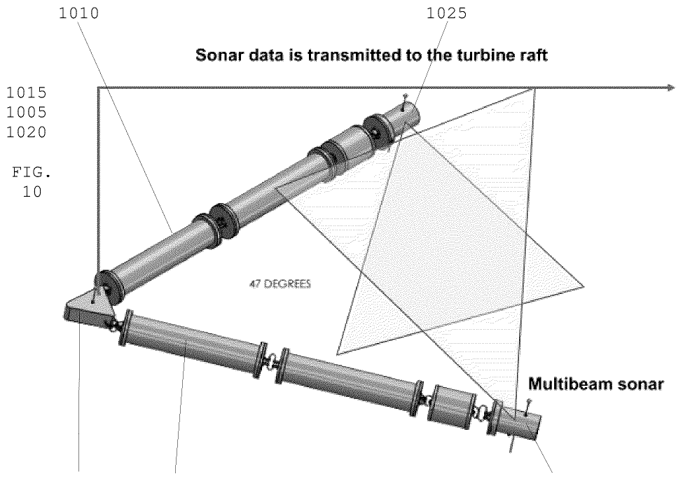

As shown in FIG. 10, the floating boom system 915 (of FIG. 9) includes flotation arms 1005, 1010 joined by a linkage 1015. In one example embodiment, the flotation arms 1005, 1010 are positioned 47 degrees apart. Located at proximal ends of each flotation arm 1005, 1010 are multi-beam sonar units 1020, 1025, such as a Gemini 720ik multi-beam sonar units, for example. Other marine multibeam imaging systems are available across a wide range of capabilities and costs from consumer/hobbyist shallow water Blueye and Sonoptics for less than $10,000 to professional and military-grade systems such as SoundMetrics, TriTech, Imagenex, Teledyne RESON SeaBat, and Teledyne BlueView with depth capabilities to 4,000 meters and ranges of up to 200 meters. Dual frequency variants of these systems employ high frequencies to enhance image quality for near-field details and achieve extended range at lower frequencies that provide somewhat lower image detail. The costs range from $20,000 to more than $100,000. The multi-beam sonar units 1020, 1025 utilize a multi-beam sonar to detect oncoming debris, which is sent via a transmitter in the linkage 1015 to the trailing turbine platforms 905, 910 (FIG. 9). Classification by a supervisory control and data acquisition (SCADA) system helps determine threat level from each sonar contact. A remote signal is sent to the turbine platform(s) at risk, which rapidly retract their turbines from the water while the debris passes. One floating boom system can protect one or more turbine platforms.

Real time object detection using multi-beam sonar was demonstrated in laboratory tests in a tow tank using a Teledyne BlueView Dual Frequency multibeam sonar. BlueView Sonar has a field of view of +40 degrees, allowing for flexibility in positioning by tilting the sensor along the vertical axis. This adjustment enables the detection of both underwater and floating debris. FIGS. 10A, 10B, 10C presents the sonar images for a concave wooden log, FIGS. 10B, and 10C shows a mass of kelp and what it looks like in a sonar image. Other items that have been detected include an oak rib from a ship, a 15-gallon polyethylene barrel, old walnut chair, Slocum glider hull, and charred plexiglass. Interference from the tank's side walls presented a significant issue. Adjusting the range and tilting the sonar angle slightly upward with a 7-degree sweep proved critical for the sonar to provide accurate imagery of both floating and submerged objects.

Images detected by the multi-beam sonar units 1020, 1025 are processed via a hybrid artificial intelligence/machine learning (AI/ML) trained algorithm to detect and recognize floating and sub-surface debris and aquatic or marine species. When debris is detected and assessed to be harmful, the rotor arm lifts the turbine to safety. Likewise, when an aquatic species is detected and assessed to be in harm's way, the rotor arm lifts the turbine out of the way so the animal can pass by safely.

Candidate options for detection include acoustic gates, acoustic cameras, mechanical detection via chains connected to string potentiometers. Recognition of shapes via machine learning has been broadly applied.

In one implementation, real-time motion/detection data/imagery is recorded using the Tritech Gemini 720 is multi-beam sonar unit.

The sonar is located on the floats of the debris avoidance system located approximately 42 meters away from the turbine platforms.

Data is collected from the sensors in near real time and transmitted (Tx-Rf) from a computer on floating boom system to a CPU onboard on the smart boom of the above water surface portion in the form of image frames.

Rx data is read and processed using a Tritech Genesis SW. Image frame (output) are transformed into real world x, y or θ, r.

The software first processes multibeam imaging sensor data to discriminate between different classes of moving objects (primarily debris and marine species) through methods such as adaptive filtering and wavelet-based time-frequency analysis. Data processing is real-time through edge computing to minimize latency. Processed data is fed into the predictive algorithm, which combines supervised deep learning for speedy object recognition and computer vision for trajectory prediction. This approach enables the algorithm to identify underwater objects and predict if they will be a threat based on the object type and trajectory relative to the marine energy device. This approach combines sonar technology with Convolutional Neural Network (CNN)-based deep learning.

The sequential procedure for AI-based object detection and collision avoidance is delineated below.

### 1. Data Acquisition (Data Image Repository)

Image Acquisition from Sonar: The data acquisition process involves deploying advanced Sonar (intelligent sensors). The images from sonar can be read directly into a desktop CPU or laptop in the first case. These images serve as the foundational dataset for the debris detection project.

Data Annotation: Annotating the sonar images is crucial before proceeding with data pre-processing. Annotation entails labeling specific features within the images, such as debris, using bounding boxes or masks. This annotated data serves as the ground truth for training the AI models, enabling them to learn and recognize debris patterns accurately.

### 2. Data Pre-Processing and Data Segmentation

Pre-processing: After data annotation, pre-processing steps are carried out to enhance the quality and suitability of the sonar images. This involves cleaning the data to remove any artifacts or noise introduced during acquisition. Normalization ensures consistent scaling across all photos, and enhancement techniques are applied to improve the overall clarity of the sonar images.

Segmentation: This process involves dividing the sonar images into meaningful segments that align with the specific requirements of the chosen framework. Segmentation ensures that the training and testing data conform to the framework's prerequisites, allowing for practical model training and evaluation. During segmentation, the sonar images are partitioned into distinct regions of interest (RoIs), considering factors such as debris shapes, sizes, and spatial distribution.

### 3. Image Processing and Classification

Debris Detection: A framework utilizes a deep-learning approach tailored explicitly for debris detection. The strategy employed for this characterization involves utilizing TensorFlow's Object Detection API in conjunction with the Faster R-CNN technique. Layers of each CNN can be classified into four categories:
Convolutional layer (CONV): This is the main layer, composed of kernels (filters) that contain learnable weights for feature extraction. Its depth is the same as the input layer, but its height and width are smaller than the input. CONV layers slide on the image to find features, and the accuracy and computational cost depend on the sliding stride.
The max pooling layer is the layer that performs down-sampling by a reduction of input size. It works by sliding a filter on the input and reduces the computational cost and the probability of overfitting.
The fully connected layer (FC) connects previous layers to all neurons. It is a vector that adds bias to input for neurons.
The SoftMax layer predicts the class object of a region proposal. It evaluates the probability of each region being an object and outputs the class with the highest probability.

Object Detection Methods: These may include Fast R-CNN, which was introduced to reduce computational time of R-CNN. Faster R-CNN is utilized because it helps recognize numerous objects in a similar image. Mask R-CNN identifies objects and their categories and provides detailed segmentation of object boundaries at the pixel level, offering a more comprehensive understanding of the scene. Finally, YOLO (You Only Look Once) is a real-time object detection algorithm that directly predicts bounding boxes and class probabilities for objects in an image. The latest versions, including YOLOv2 and YOLOv3, have improved accuracy and the ability to detect objects at different scales. TensorFlow Object Detection API is an open-source structure based on TensorFlow, which can easily construct, train, and deploy object detection models.

4. Forecasting with Time-Series Data: Forecasting or predictive modelling with a time-series data can be performed using the following neural techniques:

k-Nearest Neighbors Regressor (KNR): The KNR algorithm aims to predict an output data point starting from the closest data in the training sample, its “nearest neighbors;” the “k” number defines how many points are used to evaluate the prediction.

Decision Trees (DT): Decision Trees (DT) are an algorithm based on a decision graph in which predictions are based on “tests,” i.e., sequences of if/else questions that build a tree.

Conventional Long Short-Term Memory (LSTM): The deep feed-forward network (DEN), the basic deep learning model, consists of an input layer, hidden layers, and an output layer.

5. Image Post-Processing and Visualization: The sequence of post-processing and visualization tasks are as follows:

Post-processing: After the forecasting phase, post-processing steps involve refining the results for improved accuracy. This iterative refinement process ensures the final debris detection meets the desired benchmarks.

Error Correction: Post-processing allows for identifying and correcting errors or inaccuracies that may have occurred during the forecasting phase. This iterative refinement ensures that the results align more closely with the ground truth.

Threshold Adjustment: The post-processing steps may involve adjusting detection thresholds or criteria to filter out false positives or refine the boundaries of detected debris. This fine-tuning contributes to a more accurate and reliable debris detection outcome.

Noise Reduction: Through post-processing, noise or irrelevant information in the detection results can be reduced or eliminated. This is particularly important in underwater environments where sonar images may contain various artifacts affecting detection accuracy.

Visualization: Visualizations, including flowcharts, diagrams, and architecture illustrations, are provided to enhance understanding and demonstrate the effectiveness of the framework.

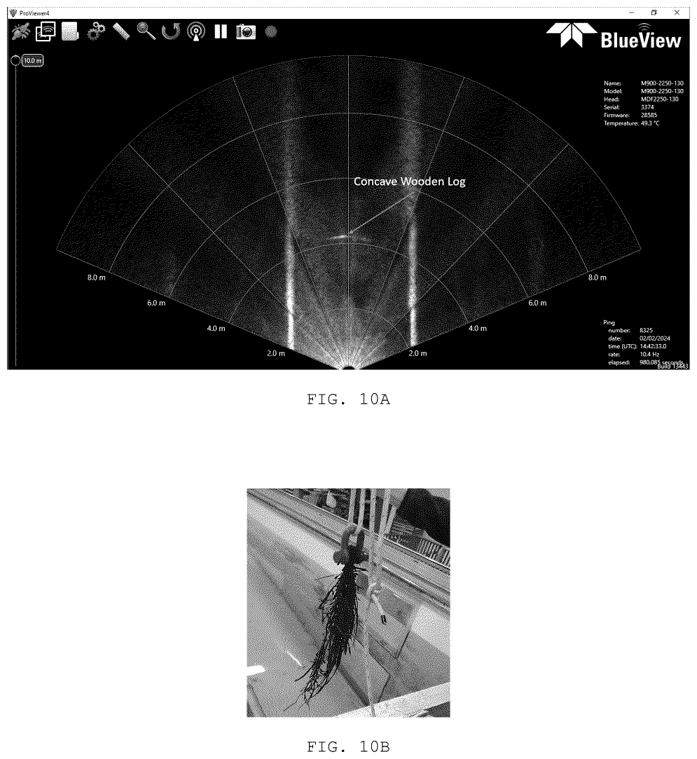

Overall system sizing for a 263 kW version occupies approximately 147 m of length along the river between anchors. Example sizing parameters are shown in FIG. 11.

Operational bounds of a full scale hydro-turbine defined by average and max cut-out currents, which in turn determines drivetrain and structural sizing.

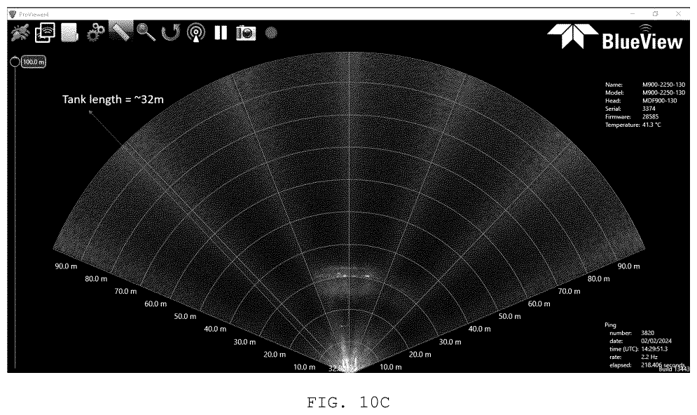

As shown in FIG. 12, transmission components are split between lower nacelle and upper mounting bracket of the transmission structure, and include, in one specific example, a 130 KW generator 1205, a lockout brake 1210, a rigid coupling 1215, a second stage helical gearbox 1220 and a drive shaft with rigid coupling 1225. The upper bracket houses the second stage gearbox, brake and generator coupling. The brake is used to lock out rotors for maintenance and/or storage.

As shown in FIG. 13, the nacelle 1300 houses the first stage transmission components and includes a right angle primary gear box 1305, a slip clutch shaft coupling 1310, a bearing set 1315, a step shaft 1320, keyed and threaded, shaft seals 1325 and a turbine 1330.

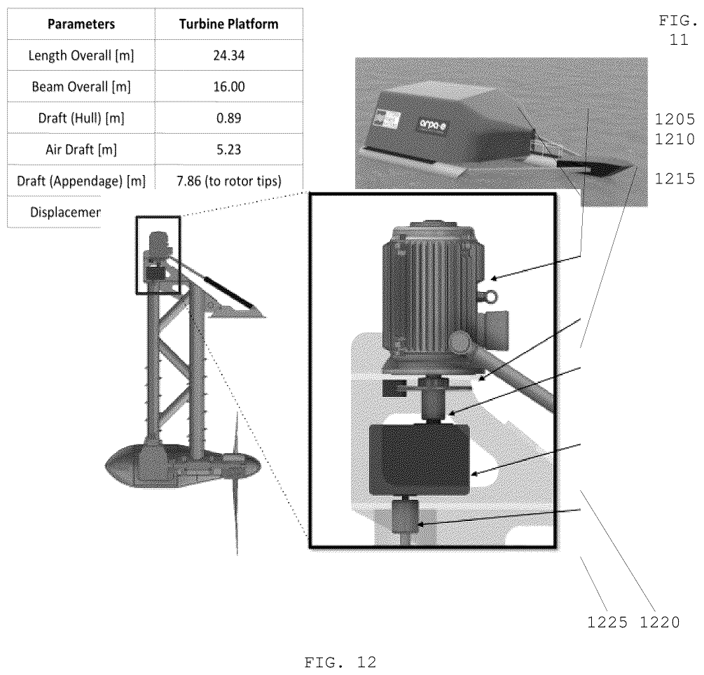

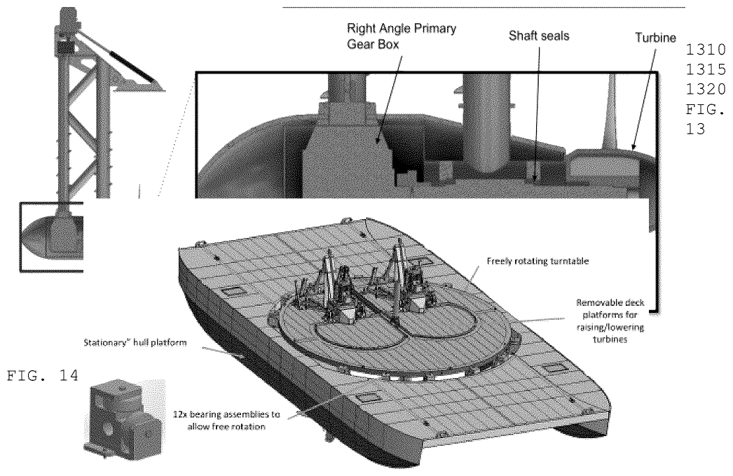

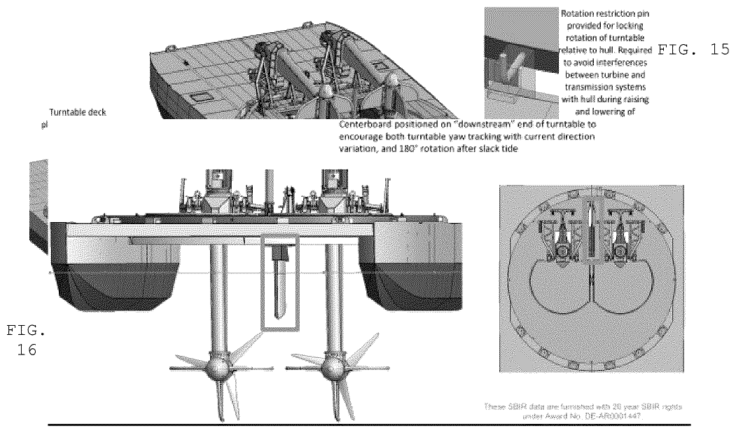

In FIGS. 14, 15 and 16, an exemplary platform design is illustrated with the superstructure and power electronics removed from view. These FIGS. illustrate the embodiment using a turntable deck. This is just one example of the means by which the platform may rotate to position the turbines into the flow when the tide changes direction. Other options that may be used depending on the specific site conditions to achieve this function include: turret is mechanically integrated into the hull internal structure, turret is mechanically integrated into exterior hull structure, separate moored buoy handles platform mooring loads and service transfer, catenary mooring, and tension leg mooring. Of these a catenary approach has the benefit of loading bolts more in pure shear and is better suited for drag embedment anchors. External turret or turret buoy is a more adaptable/modular integration of a swiveling features and is expected to allow the most system compliance in the event of a debris strike.

In one embodiment using an internal turret, one of the challenges is related to installation of the turret into the platform. This is addressed by using a clamshell structure that allows the bow portion to open like a crab's claw, or alternatively uses an arrangement of straps.

FIG. 17 illustrates an exemplary lightweight superstructure of aluminum I-beams and thin sheeting.

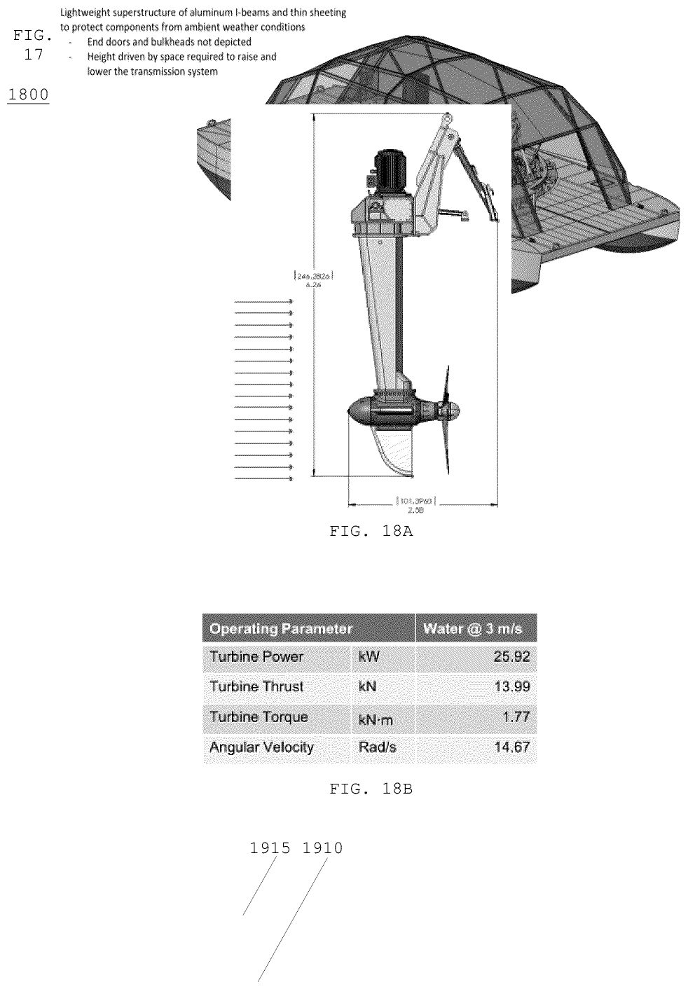

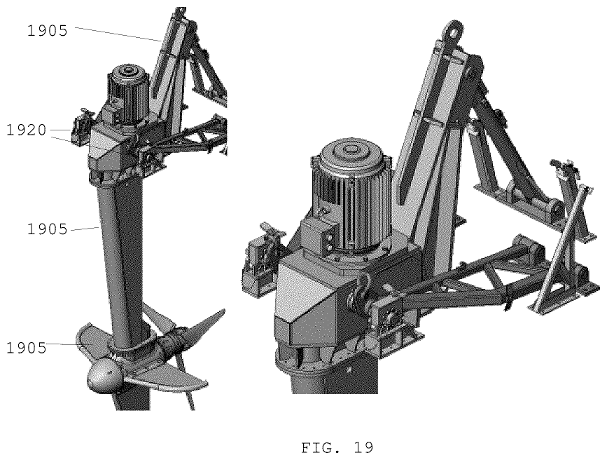

As shown in FIG. 18A, an exemplary transmission system 1800 transmits power captured by the turbine to the generator mounted above the water. It also provides debris shielding and impact absorption to protect the turbine and other system components. Sample parameters are shown in the table in FIG. 18B.

As shown in FIG. 19, each transmission module includes a power transmission assembly, a pivoting arm, an impact damper and static elements.

FIG. 20 illustrates an impact damper and mechanical fuse.

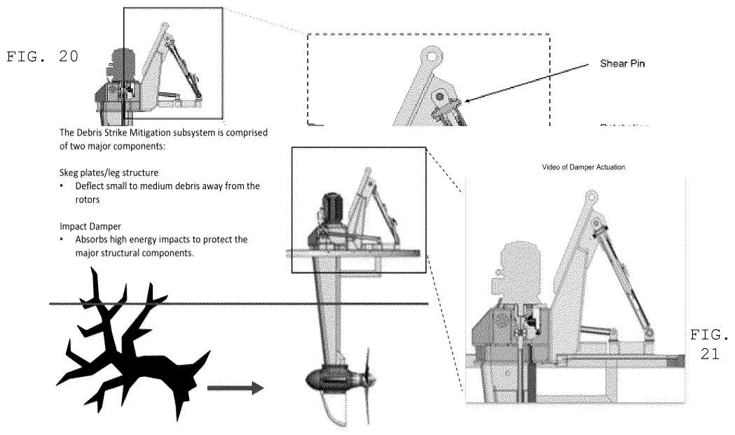

FIG. 21 illustrates an exemplary debris strike mitigation subsystem that includes a skeg plats/leg structure and an impact damper.

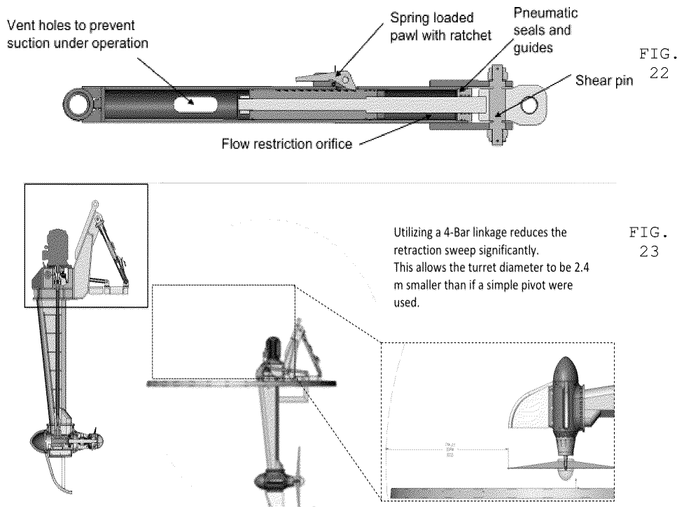

FIG. 22 illustrates an exemplary damper-impact fuse. A goal for the fusible damping link is to lessen the overall structural burden of the system by absorbing the potential impact energy into a purpose-built element instead of absorbing the impact fully into the structure of the transmission leg. This element serves a double purpose, to act as a link in the 4-bar lifting mechanism and to act as the absorption element in an impact scenario.

This absorption link can be designed as an automatically resettable hydraulic-pneumatic spring-damper, or a non-resettable pneumatic damper with a fusible link. In a preferred embodiment, the fusible link option was chosen for this design as it simplifies the subsystem and a large reduction in manufacturing/design cost. This system includes a position sensor to shut down both rotors if a breakaway link failure were to happen.

FIG. 23 illustrates an exemplary 4-bar linkage retraction system.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A turbine platform comprising:
an above water surface portion of catamaran-based design, the above water surface portion supporting a rotating turntable, which in turn supports one or more hydro-turbines, one or more generators, and one or more transmission systems; and
a below water surface portion, the below water surface portion including two or more retractable hydro-turbines linked to a generator in the above water surface portion.

2. The turbine platform of claim 1 wherein the two or more retractable turbines are located downstream of a transmission arm and are raked back to deflect debris.

3. A debris management system comprising:
a protection system for individual or multiple turbine platforms including:
a separately moored, floating boom system positioned upstream of the individual or multiple platforms.

4. The debris management system of claim 3 wherein the floating boom system comprises:
two flotation arms; and
a linkage joining the two flotation arms at an angle from each other.

5. The debris management system of claim 4 wherein each of the two flotation arms includes a distally located multi-beam imaging sonar unit to detect, track and characterize oncoming debris.

6. The debris management system of claim 5 wherein the linkage includes a transmitter configured to receive signals from the multi-beam sonar imaging units and transmit alert signals to multiple turbine platforms.

7. The debris management system of claim 6 further comprising a gate providing connection and stability across aft pontoons through a truss arm and tension member, the gate designed to open up and allow access to a maintenance tender.
